(19) United States
(12) Patent Application Publication
(10) Pub. No.: US 2026/0023576 A1
(43) Pub. Date: Jan. 22, 2026

(54) MANIFEST ENGINE SYSTEM AND METHOD FOR CONFIGURING APPLICATIONS ON AN INFORMATION HANDLING SYSTEM

(71) Applicant: Dell Products L.P., Round Rock, TX (US)

(72) Inventors: Walter Kemp, Georgetown, TX (US); Suraj M. Varma, Portland, OR (US); Trent A. Buys, Seattle, WA (US)

(73) Assignee: Dell Products L.P., Round Rock, TX (US)

(21) Appl. No.: 18/776,413

(22) Filed: Jul. 18, 2024

(51) Int. Cl. G06F 9/445; G06F 8/65

(52) U.S. Cl. CPC G06F 9/44505; G06F 8/65

(57) ABSTRACT

Embodiments of the present disclosure provide a manifest engine that configures the applications and services in an IHS (e.g., computing device) using parameters that have different namespace scopes or organizational origins. According to one embodiment, the manifest engine includes computer-executable instructions to receive a manifest associated with a target computing device, wherein the manifest stores information associated with one or more applications to be custom configured on the target computing device, and for each application, populate the fields of a template associated with the application using a configuration chain, and custom configure the application on the target computing device using the template.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems. Nevertheless, IHSs have evolved into large and complex systems capable of supporting many types of applications and services. As a result, those applications and services often have numerous individually configurable parameters, commonly referred to as configuration data, that control their operation.

### SUMMARY

Embodiments of the present disclosure provide a manifest engine that configures the applications and services in an IHS (e.g., computing device) using parameters that have different namespace scopes or organizational origins. According to one embodiment, the manifest engine includes computer-executable instructions to receive a manifest associated with a target computing device, wherein the manifest stores information associated with one or more applications to be custom configured on the target computing device, and for each application, populate the fields of a template associated with the application using a configuration chain, and custom configure the application on the target computing device using the template.

According to another embodiment, an application configuration method includes the steps of receiving, by a manifest engine, a manifest associated with a target computing device, wherein the manifest stores information associated with one or more applications to be custom configured on the target computing device, and for each application: using a configuration chain, populating the fields of a template associated with the application, and custom configuring, using the manifest engine, the application on the target computing device using the template.

According to yet another embodiment, an application configuration system includes an Information Handling System (IHS) with a manifest engine stored in a memory coupled to a processor, the memory having program instructions stored thereon that, upon execution, cause the manifest engine to receive a manifest associated with a target computing device, wherein the manifest stores information associated with one or more applications to be custom configured on the target computing device, and for each application, using a configuration chain, populate the fields of a template associated with the application, and custom configure the application on the target computing device using the template.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS that may be configured to implement embodiments described herein.

FIG. 2A illustrates an example configuration file chaining system 200 according to one embodiment of the present disclosure.

FIG. 2B illustrates an example Venn diagram showing how the inheritable configuration files may be used to form a configuration chain for the installation of applications on the computing device according to one embodiment of the present disclosure.

FIG. 3 illustrates an example answer file generating method showing how the configuration file chaining tool may process the manifest file, template files, inheritable configuration files, scripts, and operating system file to generate custom answer files for one or more applications to be installed on a computing device according to one embodiment of the present disclosure.

FIG. 4 illustrates an example manifest processing method that may be used to manage how a set of inheritable configuration files is processed to generate one or more template files according to one embodiment of the present disclosure.

FIG. 5 illustrates an example template processing method that may be used to manage how a set of template files is processed to generate one or more answer files according to one embodiment of the present disclosure.

FIG. 6 illustrates an example manifest file showing how priority among different domains may be established according to one embodiment of the present disclosure.

FIG. 7 illustrates an example operating system file showing several parameters associated with the IHS, its hardware configuration, and OS parameters according to one embodiment of the present disclosure.

FIG. 8 illustrates an example inheritable configuration file storing several parameters associated with a first application according to one embodiment of the present disclosure.

FIG. 9 illustrates an example inheritable configuration file storing several parameters associated with a custom domain according to one embodiment of the present disclosure.

FIG. 10 illustrates an example inheritable configuration file associated with the first application according to one embodiment of the present disclosure.

FIG. 11 illustrates an example template file that may be used to indicate to the configuration file chaining tool, how to generate an answer file for the first application according to one embodiment of the present disclosure.

FIG. 12 illustrates an example answer file generating script that may be executed by the configuration file chaining tool to generate the answer file for the first application according to one embodiment of the present disclosure.

FIG. 13 illustrates an example inheritable configuration file associated with the first application domain according to one embodiment of the present disclosure.

FIG. 14 illustrates an example template file that may be used to indicate to the configuration file chaining tool how to generate the additional answer file for the first application according to one embodiment of the present disclosure.

FIG. 15 illustrates an example inheritable configuration file associated with a second application domain according to one embodiment of the present disclosure.

FIG. 16 illustrates an example template file that may be used to indicate to the configuration file chaining tool, how to generate the answer file for the second application according to one embodiment of the present disclosure.

FIG. 17 illustrates an example inheritable configuration file that may be used by the configuration file chaining tool to generate the answer file for the second application according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

As mentioned previously, applications often have numerous individually configurable parameters, commonly referred to as configuration data, to control their operation. Nevertheless, custom configuration of software installation on PCs can be very complicated with many individual answer files and configuration scripts needed to install a full complement of applications. Due to overlapping common variables (e.g., hostname, MAC address, username, etc.), the answer files are prone to have similar redundant information and inconsistencies. As will be described in detail herein below, embodiments of the present disclosure provide a configuration file chaining system and method that configures the applications and services in an IHS (e.g., computing device) using parameters that have different namespace scopes or organizational origins. Additionally, the system and method provides a framework for merging some, most, or all of the various configuration settings into one or a few answer files used for each installation process, thus alleviating redundancy and user error while allowing a customer to order a system configured to their requirements.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

Cyber attackers are reportedly exploiting and abusing devices, such as platform interface protocol analyzers to steal unencrypted information, spy on network traffic, and gather information to leverage in future attacks against platform components and component interfaces (e.g., I2C, PCIe, I3C, Sensewire, SPI, etc.) of IHSs. Detection of vulnerable platform components is not an easy task, and exploiting unpatched vulnerabilities could allow the attacker to take control of an IHS. Some example platform security risks may include compromised security in which hostile component insertion and/or compromised firmware updates can cause supply chain security issues. Another example platform security risk may include confidentiality and integrity risks in which data transfers that are unencrypted may be vulnerable to eavesdropping, stealing, and tampering. Additionally, non-compliant security configuration errors, certificate management, platform security trust, and the like could lead to non-compliance with industry standard security policies. The FIDO Device Onboard (FDO) standard has been developed to alleviate such problems and reduce management overhead in maintaining and establishing the platform security involving non-password secure communication techniques within the IHS infrastructure domain.

A typical server may be configured with numerous devices, such as I/O cards, on-board graphics adapter cards, Ethernet adapters, sound adapters, power management circuitry, and the like that may be replaced or added to from time to time due to a desire to upgrade the IHS's performance and/or due to a failure of an existing device. Such devices are often configured with executable firmware that can be updated with new firmware on an as needed basis. This feature, however, could potentially cause security issues due to malware that can be illicitly installed on those devices. One particular security susceptibility may involve the supply chain used between a vendor of the device and the end user who configures the device in their server. That is, an illicit actor may, during shipping of the device from vendor to end user, install malware on the device such that when installed on the server, causes one or more security breaches in that server. According to embodiments of the present disclosure, systems and methods for validating the authenticity of devices used in information handling systems (IHSs) are provided that ensures the firmware and other attestation data created by the vendor is validated for use by an IHS of an end user as will be described in detail herein below.

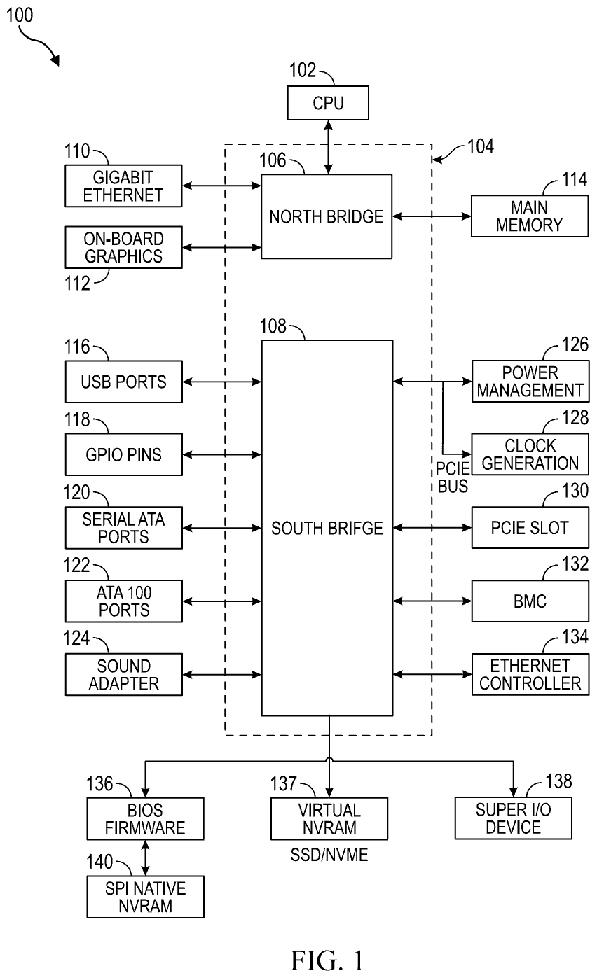

FIG. 1 shows an example of an IHS 100 that may be configured to implement embodiments described herein. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, etc. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

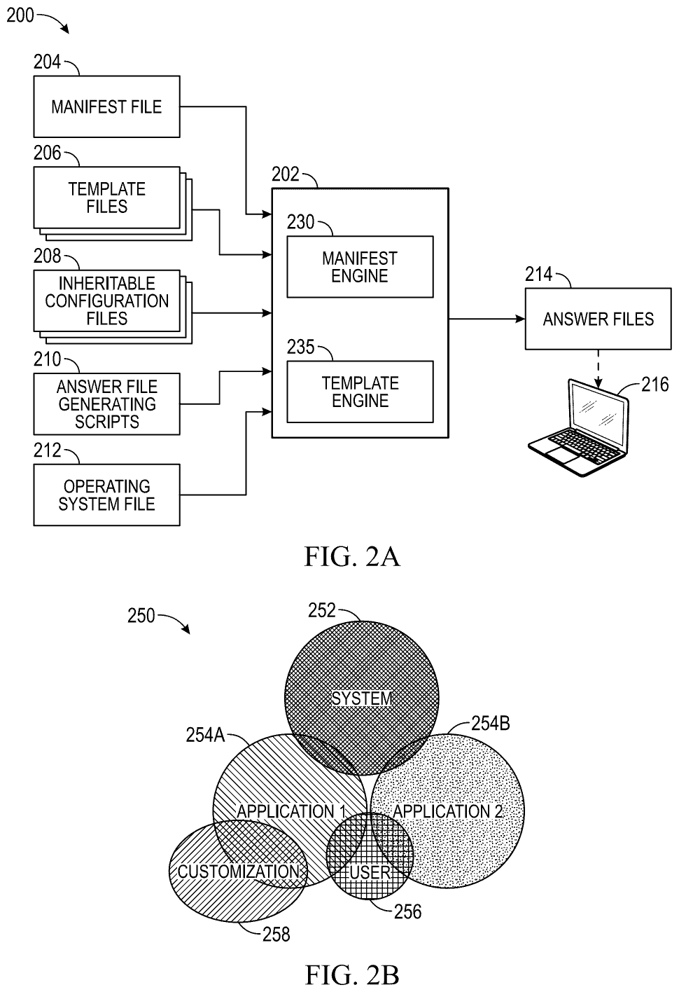

FIG. 2 illustrates an example configuration file chaining system 200 according to one embodiment of the present disclosure. The configuration file chaining system 200 includes a configuration file chaining tool 202 with a manifest engine 230 and a template engine 235 that will be described in detail herein below. The configuration file chaining tool 202 receives a manifest file 204, one or more template files 206, and multiple inheritable configuration files 208, and generates one or more answer files 214 that may be used to provide a custom configuration for an IHS 216, such as workstation, laptop computer, tablet computer, and the like. The configuration file chaining tool 202, for example, may be stored on and executed on any suitable computing device, such as IHS 100. Additionally, while the manifest file 204, inheritable configuration files 208, scripts 210, and/or template files 206 are described herein as being files stored on an IHS, it should be appreciated that either of the manifest file 204, inheritable configuration files 208, scripts 210, and/or template files 206 may exist as any suitable data structure, such as records stored in a database.

The answer files 214 may be used to configure any suitable type of computing device, such as IHS 100. For example, the answer files 214 may be used by a vendor of IHSs in which each IHS may have a custom configuration as specified by each customer. As another example, the answer files 214 may be used by a vendor of IHSs that provides multiple IHSs to an organization (e.g., a business, a school, etc.). Additionally, the answer files 214 are generated in a manner such that they may be used by an application installer on a Windows-based Operating System (OS), or by a service running on a UNIX-based or LINUX-based OS to update the configuration files of applications after they have been installed.

Referring now to FIG. 2B, an example Venn diagram 250 is shown to illustrate how the inheritable configuration files 208 may be used to form a configuration chain for the installation of applications on the computing device 216. Complete application installations may involve several different domains. For example, the Venn diagram 250 may include a system (operating system) domain 252, two separate application domains 254a, b, a user domain 256, and a customization domain 258.

The system domain 252 includes application settings which may extend across the entire operating system, such as IP Address, Hostname, Admin Contact, and the like. The Application 1 domain 254a settings may include application settings like installation directory, network port numbers, application feature settings, and the like. The application 1 domain may include defaults that can be overridden by customization provided by the customer using the inheritable configuration file 208. Similar to the application 1 domain 254a, the application 2 domain 254b may include application settings specific to the behaviors or settings for an application 2. Generally, the application settings would include defaults created by the vendor of the computing device 216 or the software vendor as a “default” installation. The user domain 256 may include application settings associated with the user of the computing device 216, such as name, contact information, email address, and the like.

The system file 212 may be used to store application settings associated with the system domain 252, while the inheritable configuration file 208 may be used to store application settings associated with the application 1 domain 254a, the application 2 domain 254b, the user domain 256, and the customization domain 258. The configuration file chaining tool 202 may use the inheritable configuration file 208, and system file 212 to generate a configuration chain in which application settings may be set in the answer files 214 according to the sequential order in which the inheritable configuration file 208 and system file 212 are processed. That is, an ensuing inheritable configuration file 208 or system file 212 that is processed after a previous inheritable configuration file 208 or system file 212 may inherit the application settings of the previous domain.

The end result would have two answer files 214 generated for the installation and/or configuration of a corresponding two applications, namely application 1, and application 2. The first application would contain properties from the system domain plus the application 1 domain which are overridden by the customer provided customizations from the customization domain 258. Finally, any user specific settings would also be applied to the installation configuration from the user domain 256. The second application would contain the system properties, the default application properties, and the user specific settings from the user domain 256.

There are many different models of different complexity possible with the inheritable configuration files 208. For example, a given installation platform may include a four-layer model that includes hardware, operating system, application, and user domains. A MAC address would exist in the hardware layer, but its value might need to be included in other locations in the IHS 100 as well as in other IHSs 100, such as could occur with an organization that manages multiple IHSs 100. Thus, to properly configure an application, the application layer would inherit certain configuration values from the operating system domain and hardware layer domain. The user would create a set of configuration options for each of their desired layers so that different applications would use the same operating system and hardware layers, which simplifies the creation of answer files 214 and provides the same data consistently. Each inheritable configuration file 208 may include parameters or settings associated with a particular domain, which may be used to provide a custom configuration for an application installed on the IHS 100.

The resulting parameters recorded in the answer file generating scripts 210 may be based upon a priority of each domain, such as what may be encountered when a certain parameter is specified in more than one domain. In one embodiment, the priority of each domain may be specified in the manifest file 204. In some aspects, a domain that is processed after a previous domain could be considered to inherit the parameters of the previous domain. Additionally, the inheritable configuration files 208 could be considered to be chained in that the precedence of the parameters specified in a previous domain may directly affect the resulting parameters of an ensuing domain.

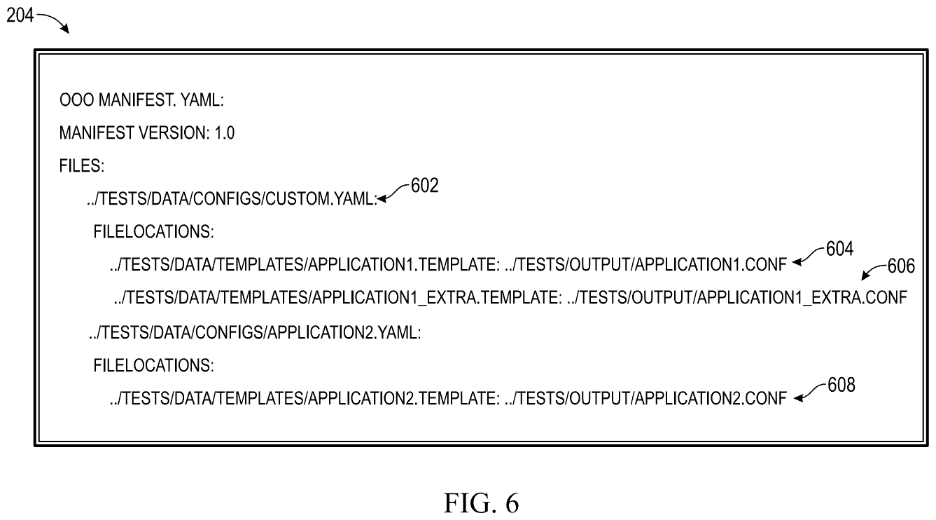

Referring now to FIG. 6, an example manifest file 204 is shown indicating how priority among different domains may be established. The manifest file 204 described herein is a Yet Another Markup Language (YAML) file, although any type of language syntax (e.g., SGML, XML, etc.) may be used. The manifest file 204 includes a number of lines that each specifies a particular domain embodied as template files 206 and inheritable configuration files 208 along with their location. As shown, the domains may include a custom domain 602, an application1 domain 604, an application_extra domain 606, and an application2 domain 608. As will be described in detail herein below, domains toward the top of the manifest file 204 will be given precedence (priority) over those toward the bottom of the manifest file 204. Thus, the custom domain 602 will be given the highest priority, while the application2 domain 608 will be given the lowest priority.

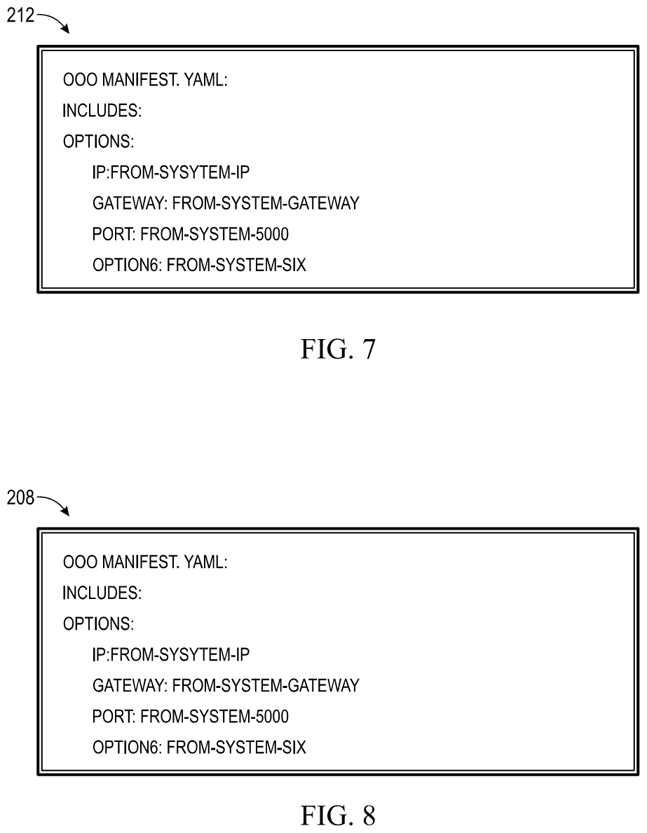

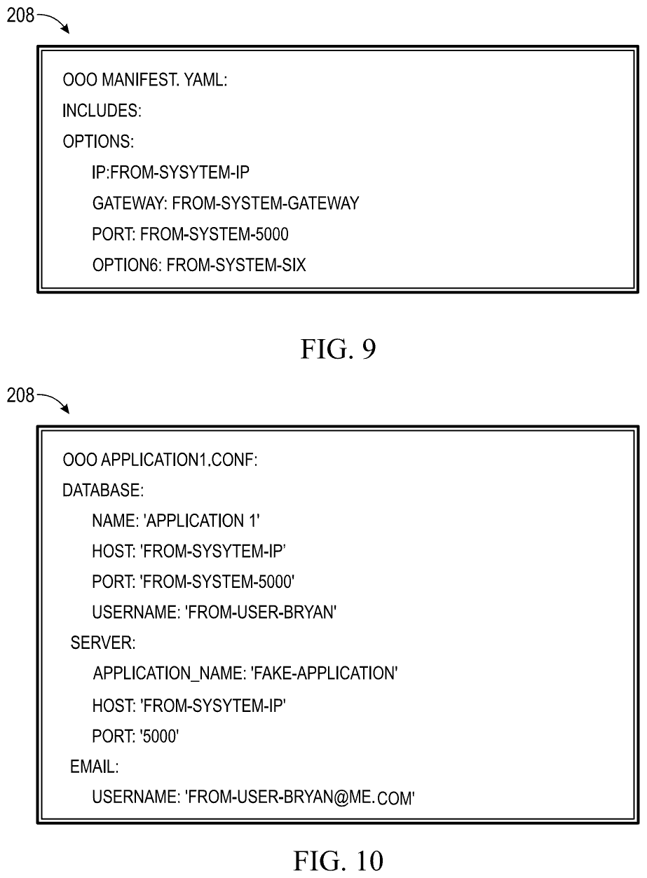

FIG. 7 shows an example operating system file 212, which although not specified in the manifest file 204, includes parameters associated with the IHS 100, its hardware configuration, and OS parameters, and is the highest level domain. FIG. 9 shows the inheritable configuration file 208 associated with a user domain that may include parameters unique to the user, such as username, contact information, email address, and the like. While the user domain is not specified in the manifest file 204, it exist as default and has a priority directly below the system domain. FIG. 8 shows the inheritable configuration file 208 associated with the custom domain 602 that may include parameters specified by the user to modify the application behavior or performance.

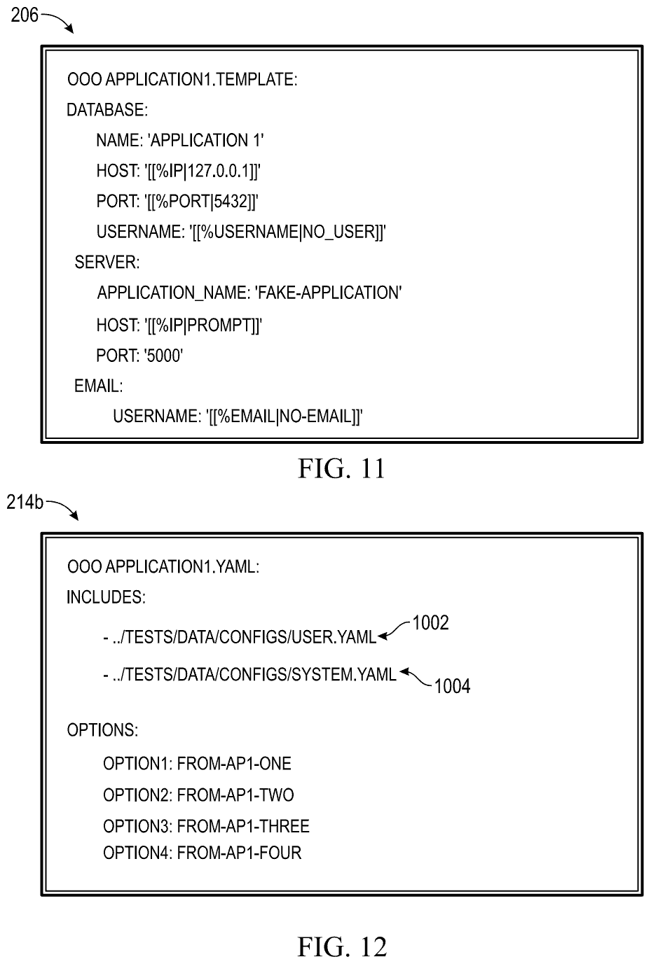

FIGS. 10, 11, and 12 show files associated with the first application. In particular, FIG. 10 shows the inheritable configuration file 208 associated with the application1 domain and may include custom parameters associated with a first application using the answer file 214. FIG. 11 shows the template file 206 that may be used to indicate to the configuration file chaining tool 202, how to generate the answer file 212 for the first application. FIG. 12 shows the answer file generating script 210a that may be executed by the configuration file chaining tool 202 to generate the answer file 214 for the first application. The answer file 214a has two entries specifying two includes files, namely a user .yaml file 1002 and a system .yaml file 1004. When the configuration file chaining tool 202 encounters these entries, it knows to process the user domain and the system domain before processing the current application1 domain.

Each template file 206 specifies the type of configuration data (e.g., username, port values, host IP address, configuration options, etc.) that an application installer or configuration tool would expect to see. Additionally, each template file 206 specifies a format or structure of the configuration data that an application installer or configuration tool would expect to see. As such, the template file 206 is generated such that the template engine 235 generates the answer file 214 with the type of configuration data and structure that can be used by the installer or configuration tool.

The template engine 235 is configured to provide variables that can either be provided by a configuration file or by a default value within the template file itself. This allows for the completion of the file without all of the possible values needing to be defined with the configuration data. For example, if the template file 206 were to be used as an answer file for a .msi installer, the vendor would be able to provide a default value that would only be overridden if the new configuration file specifically provides a new value. The template engine 235 provides the location of the template file, the configuration data, and the final destination of the file once the substitutions have been completed. The template engine 235 may read through the template file 206 and upon finding one of the areas to be changed, which is denoted by a specific and unique character delimiter, will determine the name of the substituted variable. If that variable is defined by the configuration data, then the delimited section of text will be replaced by that value from the configuration file. If that value is not provided by the configuration data, then the default value provided by the template file is used. As shown in FIG. 11, for example, entries in the template file 206 may be provided in the form: ‘[[% variable_name|default_value|prompt]],’ which includes three sections. The double open and closed brackets and % sign are the delimiter of the start and end section of the templated text. The first part is the variable name that might exist within the configuration data, the second part, after the | or ‘pipe’ symbol would be the default value which would be substituted if there is nothing provided in the configuration data. The remaining section contains a prompt for the customer to provide the answer. It should be noted that in other embodiments, other types of delimiters may be used. For another example, an entry of the form [[% hostname|host.example.com|What is the hostname]] would indicate that if the configuration data has hostname defined as ‘example.dell.com,’ then the hostname would be set to ‘example.dell.com.’ However, if hostname does not exist in the configuration data, then the hostname value in the templated file would be set to ‘host.example.com.’ If the keyword ‘prompt’ exists in the entry, then the configuration data for that entry may be posed as a question to the user via a GUI.

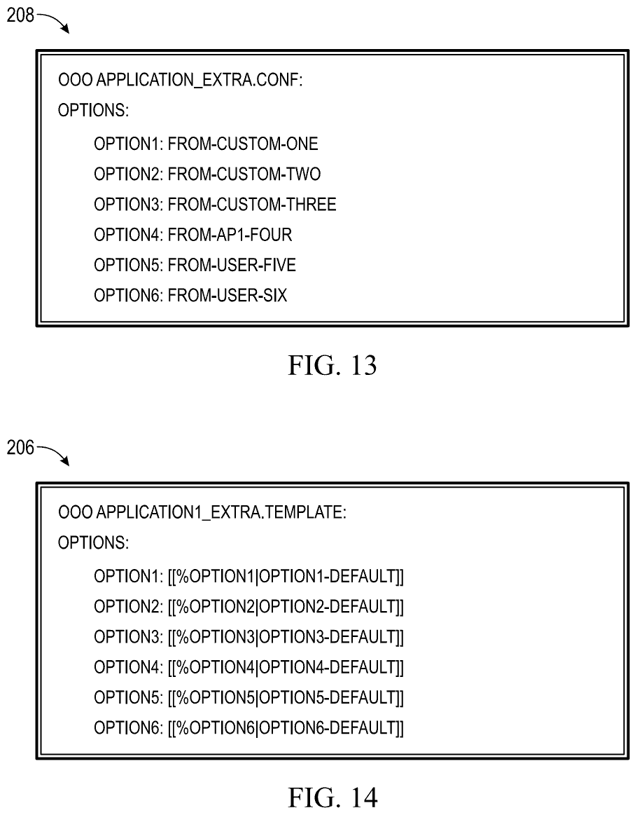

FIGS. 13 and 14 show files associated with an additional (extra) answer file 214 that may be generated for the first application. That is, the configuration file chaining tool 202 may be able to generate multiple answer files 214 for each application. FIG. 13 shows the inheritable configuration files 208 associated with the application1 domain and may include extra custom parameters associated with the first application to be installed on the answer files 214. FIG. 14 shows the template files 206 that may be used to indicate to the configuration file chaining tool 202, how to generate the additional answer file 212 for the first application.

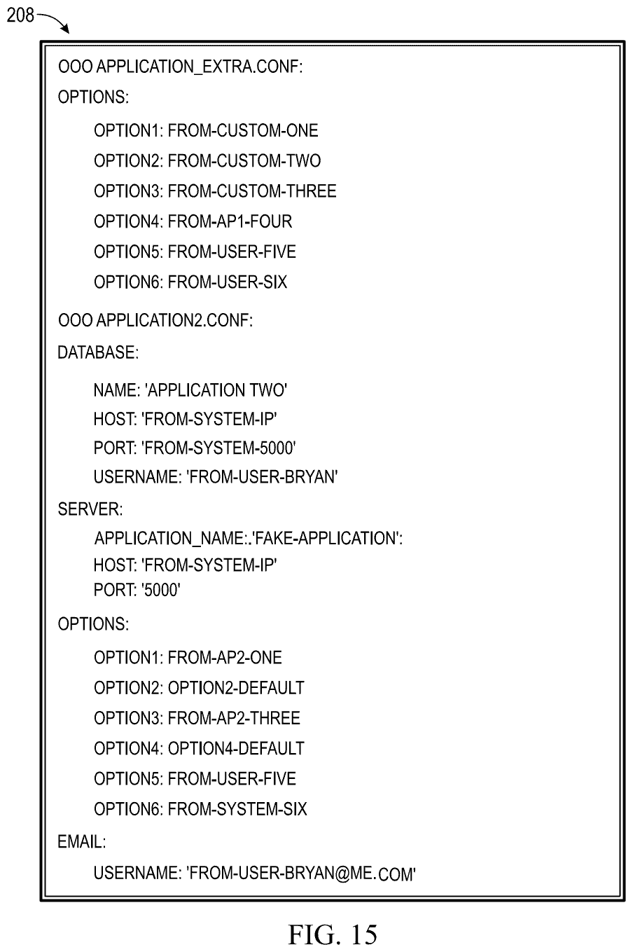

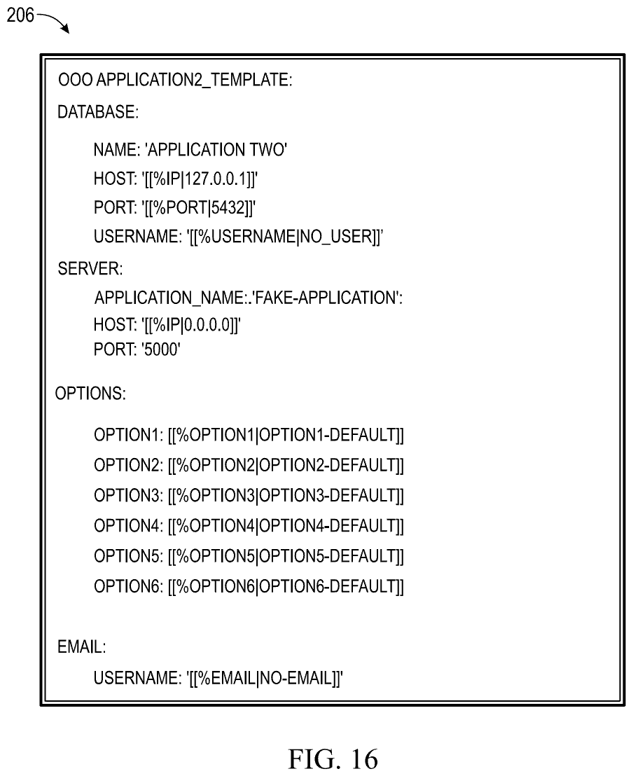

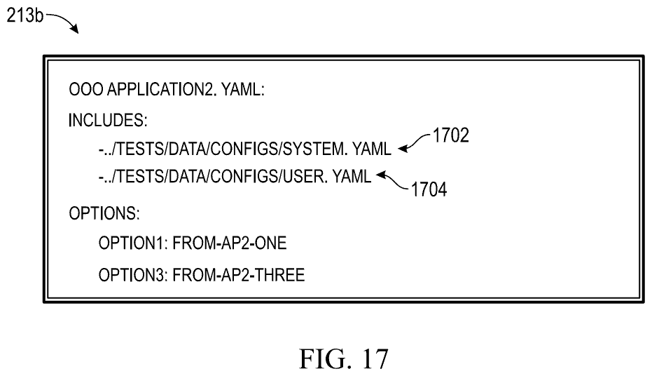

FIGS. 15, 16, and 17 show files associated with a second application. In particular, FIG. 15 shows the inheritable configuration file 208 associated with the application2 domain and may include custom parameters associated with the second application to be installed on the answer files 214. FIG. 16 shows the template file 206 that may be used to indicate to the configuration file chaining tool 202, how to generate the answer file 212 for the second application. FIG. 17 shows the inheritable configuration file 208 that may be used by the configuration file chaining tool 202 to generate the answer file 214b for the second application. The answer file generating scripts 210b has two entries specifying two includes files, namely a user .yaml file 1702 and a system .yaml file 1704. When the configuration file chaining tool 202 encounters these entries, it knows to process the user domain and the system domain before processing the current application2 domain.

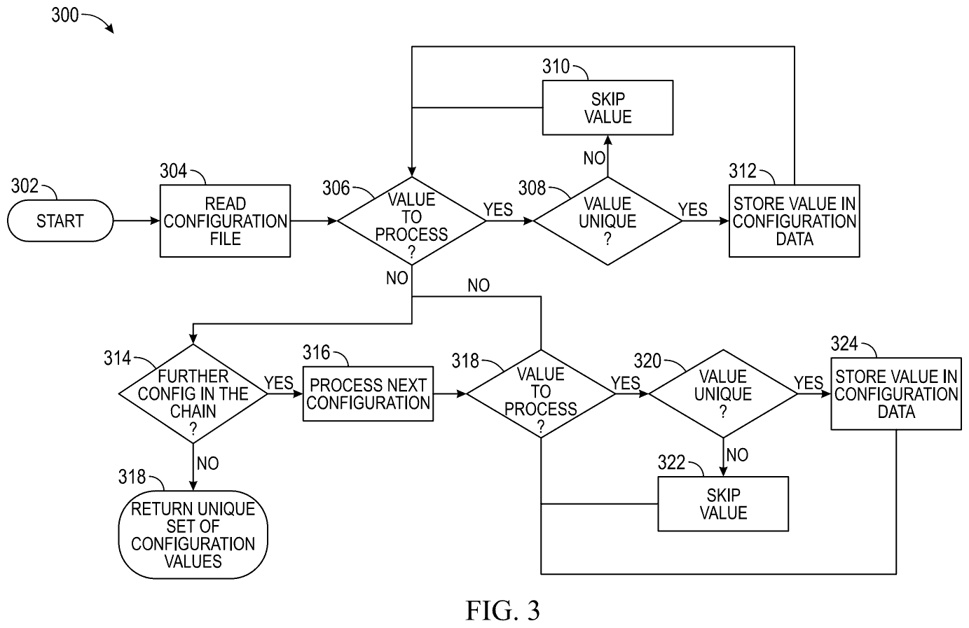

Referring now to FIG. 3, an answer file generating method 300 is shown illustrating how the configuration file chaining tool 202 may process the manifest file 204, template files 206, inheritable configuration files 208, scripts 210, and operating system file 212 to generate custom answer files 214 for one or more applications to be installed on a computing device 216 according to one embodiment of the present disclosure. Additionally or alternatively, the answer file generating method 300 may be performed by the configuration file chaining tool 202 as described above with reference to FIG. 2. In a particular example, the answer file generating method 300 may be performed at a vendor site when a customer orders (e.g., purchases) an IHS 100, such as a workstation or a laptop computer, and specifies one or more applications to be pre-installed with certain customization options to each application.

Initially, a manifest file 204, template files 206, inheritable configuration files 208, scripts 210, and an operating system file 212 may be generated. In some cases, an existing group of manifest file 204, template files 206, inheritable configuration files 208, scripts 210, and operating system file 212 may be obtained and certain parameters modified according to the customization ordered by the customer.

At step 302, the method 300 begins. Thereafter at step 304, the method 300 reads in a configuration file that includes one or more custom parameters to be used when installing an application. The configuration file may be a first of multiple configuration files to be processed. In one embodiment, the method 300 may sequentially read each of multiple configuration files according to an ordered list such that any parameters specified in a previously read configuration file would take precedence (priority) over any ensuing configuration files that are read. In another embodiment, the configuration file may be an operating system file 212 as described above with reference to FIG. 7. Although the method 300 is described as reading (accessing) configuration files, it should be appreciated any suitable form of data structure (e.g., a record stored in a database) may be used to access configuration data.

At step 306, the method 300 determines whether any parameters in the configuration file need to be processed. That is, the method 300 may sequentially process each entry or line the configuration file. If a parameter exists that needs to be processed, processing continues at step 308; otherwise, processing continues at step 314.

At step 308, the method 300 determines whether the parameter value is unique; that is, whether the parameter value has been previously set, such as being hard-coded in a template file 206. If the parameter value is unique, processing continues at step 312 in which the parameter value is stored in the configuration data; other processing continues at step 310 in which the parameter value is skipped (i.e., not stored in the configuration data). In this manner, even if two or more configuration files all have a particular parameter that is to be set, the parameter stored in the first processed configuration file will be used. Thereafter, processing continues processing again at step 306 to process the next parameter in the configuration file.

Step 314 is performed after all of the parameters stored in the first configuration file have been processed. At step 314, the method 300 determines whether any further configuration files need to be processed. If so, processing continues at step 316 to begin processing the next configuration file; otherwise, processing continues at step 318 in which the unique set of configuration values are returned so that one or more answer files can be generated for installation of one or more applications in a target IHS.

At step 316, the method 300 begins processing the next configuration file. In one embodiment, the sequence of configuration files to be processed may be included in a manifest file 204. At step 318, the method 300 determines whether any parameters in the current configuration file need to be processed. If a parameter exists that needs to be processed, processing continues at step 320; otherwise, processing continues at step 314 in which the method 300 determines whether any additional configuration files need to be processed.

At step 320, the method 300 determines whether the parameter value is unique; that is, whether the parameter value has been previously set, such as by a previously processed configuration file. If the parameter value is unique, processing continues at step 324 in which the parameter value is stored in the configuration data; other processing continues at step 322 in which the parameter value is skipped (i.e., not stored in the configuration data). Thereafter, processing continues processing again at step 318 to process the next parameter in the configuration file.

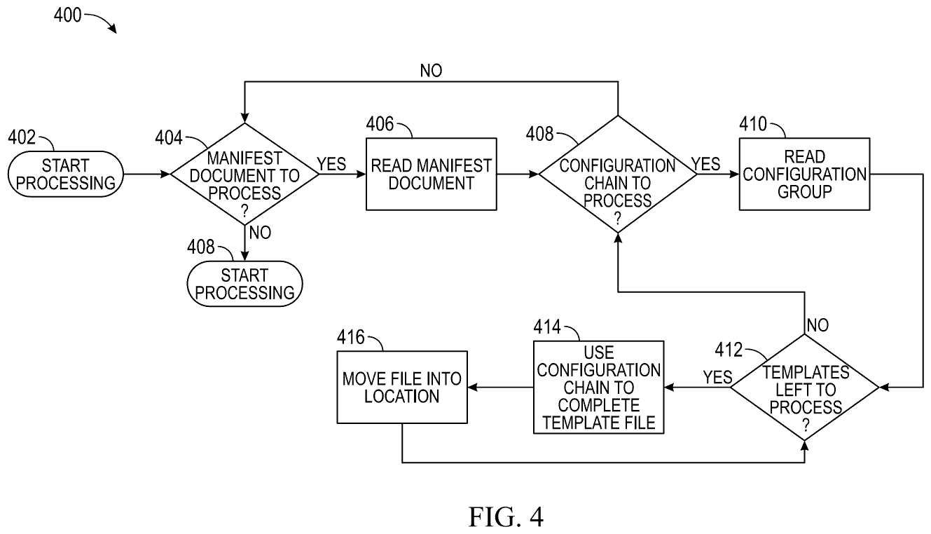

FIG. 4 illustrates an example manifest processing method 400 that may be used to manage how a set of inheritable configuration files 208 is processed to generate one or more template files 206 according to one embodiment of the present disclosure. Additionally or alternatively, the manifest processing method 400 may be performed by the manifest engine 230 as described above with reference to FIG. 2.

Initially at step 402, the method 400 begins. At step 404, the method 400 determines whether any manifest files 204 need to be processed. That is, the manifest processing method 400 may be configured to process multiple manifest files 204 in a first in first out (FIFO) queue. Such cases may exist in a manufacturing setting in which an IHS vendor may provision multiple IHSs (e.g., workstations, laptop computers, etc.) for an enterprise customer that has ordered a relatively large quantity of IHSs in which each is to have a configuration that may be slightly different from one another.

At step 406, the manifest processing method 400 reads the first or next manifest file 204, and then determines whether a configuration chain to be processed exists at step 408. If so, processing continues at step 410 to process that manifest file 204; otherwise, processing continues at step 404 to determine whether any additional manifest files 204 need to be processed.

At step 410, the manifest processing method 400 reads a configuration group identified in the manifest file 204. In one embodiment, a configuration group may include one or more files (e.g., inheritable configuration files 208, operating system file 212, etc.) associated with a template, such as a template file 206. Thereafter at step 412, the manifest processing method 400 determines whether any templates remain to be processed. If so, processing continues at step 414; otherwise, processing continues at step 408 to determine whether another configuration chain to be processed.

At step 414, the manifest processing method 400 uses the configuration chain (e.g., the ordered list of configuration files) to complete or fully process the template file 206, and at step 416, move the completed template file 206 to its final location in a memory of the IHS 100. Thereafter, processing continues at step 412 to determine whether any additional template files 206 need to be processed. Thus as can be clearly seen, the manifest processing method 400 processes the inheritable configuration files 208 in a manner such that the parameters specified in each inheritable configuration files 208 representing a domain inherit the parameters of a previously processed domain.

The aforedescribed method 400 may be performed for each batch of manifest files 204 that are to be processed. Nevertheless, when use of the manifest processing method 400 is no longer needed or desired, the process ends.

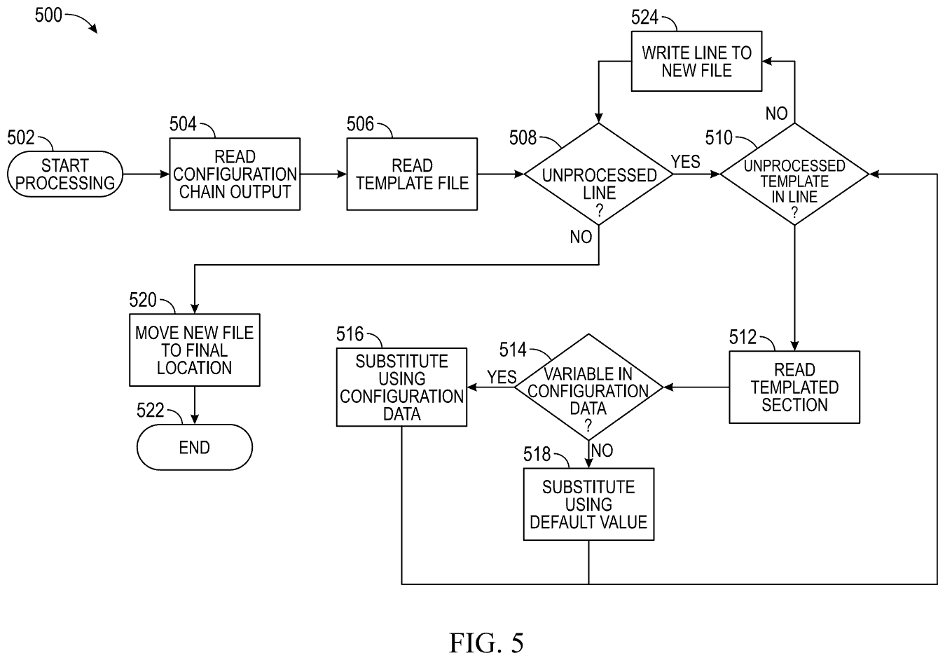

FIG. 5 illustrates an example template processing method 500 that may be used to manage how a set of template files 206 is processed to generate one or more answer files 214 according to one embodiment of the present disclosure. Additionally or alternatively, the manifest processing method 400 may be performed by the template engine 235 as described above with reference to FIG. 2. In one embodiment, the manifest processing method 400 may use the templates 206 that have been generated by the manifest processing method 400 as described above with reference to FIG. 4.

Initially at step 502, the template processing method 500 begins. At step 504, the template processing method 500 reads the configuration chain output to determine what template files 206 are to be processed. The template processing method 500 then reads a template file 206 identified from the configuration chain output at step 506, and determines, for each line in the template file 206, whether any lines still remain to be processed at step 508. If so, processing continues at step 510; otherwise, processing continues at step 520.

At step 510, the template processing method 500 determines whether an unprocessed parameter exists in the current line. If an unprocessed parameter exists, processing continues at step 512; otherwise, processing continues at step 524 in which the template processing method 500 writes the parameter to the answer file 214 and continues processing at step 508.

At step 512, the template processing method 500 reads the parameter, and at step 514, determines whether the parameter exists in the configuration data for the currently processed template file 106. If so, processing continues at step 516 in which the parameter is substituted for the existing default value. If, however, the parameter does not exist, the template processing method 500 substitutes the default value for that parameter at step 518. The template processing method 500 then continues processing at step 510 to process the next line in the template file 206.

When all parameters have been processed at step 510, and all lines in the template file 206 have been processed, the template processing method 500 then stores the answer file 214 associated with the currently processed template file 206 is stored in a memory of the IHS 100 after which the template processing method 500 ends at step 522.

The template processing method 500 may be performed repeatedly for each template file 206 in the configuration chain. Nevertheless, when use of the template processing method 500 is no longer needed or desired, the process ends.

Although FIGS. 3, 4, and 5 describe example methods 300, 400, and 500 that may be performed to generate one or more answer files 214 using a chained group of inheritable configuration files 208, the features of the methods 300, 400, and 500 may be embodied in other specific forms without deviating from the spirit and scope of the present disclosure. For example, either of the methods 300, 400, and 500 may perform additional, fewer, or different operations than those described in the present examples. For another example, either of the methods 300, 400, and 500 may be performed in a sequence of steps different from that described above. As yet another example, certain steps of either of the methods 300, 400, and 500 may be performed by other components in the IHS 100 other than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a processor; and
a manifest engine stored in a memory coupled to the processor, the memory having program instructions stored thereon that, upon execution, cause the manifest engine to:
receive a manifest associated with a target computing device, wherein the manifest stores information associated with one or more applications to be custom configured on the target computing device;
for each application:
using a configuration chain, populate the fields of a template associated with the application; and
custom configure the application on the target computing device using the template.

2. The IHS system of claim 1, wherein the program instructions, upon execution, further cause the manifest engine to generate the configuration chain:
sequentially receive a plurality of data structures, the data structures storing configuration data associated with a plurality of domains that each have a different level of priority relative to one another, wherein the configuration data comprises one or more parameters for an application; and
for each data structure, when the configuration data comprises a parameter for the application and when the parameter does not exist in a template associated with the application, store the parameter in the template.

3. The IHS of claim 2, wherein at least one of the data structures comprises a configuration file.

4. The IHS of claim 1, wherein the program instructions, upon execution, further cause the manifest engine to generate an answer file using the template, wherein the answer file is used to configure the application on the IHS.

5. The IHS of claim 1, wherein the manifest comprises a file.

6. The IHS of claim 1, wherein the acts of sequentially receiving a plurality of data structures and storing the parameter in the template are performed at a vendor site of the IHS.

7. The IHS of claim 1, wherein the program instructions, upon execution, further cause the manifest engine to configure the application after installation of the application, wherein the application is a Linux-based application.

8. The IHS of claim 1, wherein the program instructions, upon execution, further cause the manifest engine to configure the application during installation of the application, wherein the application is a Windows-based application.

9. The IHS of claim 1, wherein the parameter is a configuration setting of the application.

10. An application configuration method comprising:
receiving, by a manifest engine, a manifest associated with a target computing device, wherein the manifest stores information associated with one or more applications to be custom configured on the target computing device;
for each application:
using a configuration chain, populating the fields of a template associated with the application; and
custom configuring, using the manifest engine, the application on the target computing device using the template.

11. The application configuration method of claim 10, further comprising, to generate the configuration chain:
sequentially receiving a plurality of data structures, the data structures storing configuration data associated with a plurality of domains that each have a different level of priority relative to one another, wherein the configuration data comprises one or more parameters for an application; and
for each data structure, when the configuration data comprises a parameter for the application and when the parameter does not exist in a template associated with the application, storing the parameter in the template.

12. The application configuration method of claim 10, further comprising generating an answer file using the template, wherein the answer file is used to configure the application on the IHS.

13. The application configuration method of claim 10, wherein the manifest comprises a file.

14. The application configuration method of claim 10, further comprising performing the acts of sequentially receiving the plurality of data structures and storing the parameter in the template at a vendor site of the IHS.

15. The application configuration method of claim 10, further comprising configuring the application after installation of the application, wherein the application is a Linux-based application.

16. The application configuration method of claim 10, further comprising configuring the application during installation of the application, wherein the application is a Windows-based application.

17. An application configuration system comprising:
an Information Handling System (IHS) comprising a manifest engine stored in a memory coupled to a processor, the memory having program instructions stored thereon that, upon execution, cause the manifest engine to:
receive a manifest associated with a target computing device, wherein the manifest stores information associated with one or more applications to be custom configured on the target computing device;
for each application:
using a configuration chain, populate the fields of a template associated with the application; and
custom configure the application on the target computing device using the template.

18. The application configuration system of claim 17, wherein the program instructions, upon execution, further cause the IHS to generate an answer file using the template, wherein the answer file is used to configure the application on the IHS.

19. The application configuration system of claim 17, wherein the manifest comprises a file.

20. The application configuration system of claim 17, wherein the parameter is a configuration setting of the application.
